(19) United States
(12) Patent Application Publication
(10) Pub. No.: US 2004/0080730 A1
(43) Pub. Date: Apr. 29, 2004

(54) System and method for clamping a device holder with reduced deformation

(76) Inventor: Michael Binnard, Belmont, CA (US)

Correspondence Address: The Law Office of Steven G. Roeder, 5560 Chelsea Avenue, La Jolla, CA, 92037, US

(21) Appl. No.: 10/282,692

(22) Filed: Oct. 29, 2002

(51) Int. Cl. G03B 27/42

(52) U.S. Cl. 355/53

(57) ABSTRACT

A stage assembly (224) for moving and positioning a device (300) includes a device table (308), a device holder (312) that retains the device (300), and a stage mover assembly (204). In some embodiments, the stage assembly (224) allows precise rotation of the device (300) between a first position and a second position. Additionally, the stage assembly (224) can include a lock assembly (342) that selectively locks the device holder (312) to the device table (308) without influencing the flatness of the device (300) and without deflecting and distorting the device holder (312) and the device (300).

### FIELD OF THE INVENTION

The present invention is directed to a stage assembly for moving and positioning a device.

### BACKGROUND

Exposure apparatuses are commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, and a measurement system. The semiconductor wafer includes a plurality of chip alignment marks that identify the location of the chips on the semiconductor wafer.

Typically, the wafer stage assembly includes a wafer stage base, a wafer stage including a wafer holder that retains the wafer, and a wafer mover assembly that precisely positions the wafer stage and the wafer. Somewhat similarly, the reticle stage assembly includes a reticle stage base, a reticle stage that retains the reticle, and a reticle mover assembly that precisely positions the reticle stage and the reticle. In order to obtain precise relative positioning, the position of the reticle stage and the wafer stage are constantly monitored by the measurement system. With this information, the wafer mover assembly precisely positions the wafer and the reticle mover assembly precisely positions the reticle.

The wafer mover assembly moves the wafer stage and the wafer between an alignment position and an operational position. In the alignment position, the wafer is loaded onto the wafer stage. Subsequently, in the alignment position, an alignment device, e.g. a microscope, is used to align and determine the position of the chip alignment marks of the wafer relative to the wafer stage and the measurement system. In the operational position, a projection device, e.g. a projection microscope, is used to check alignment of the wafer relative to the reticle through the optical assembly of the exposure apparatus. Finally, in the operational position, images from the reticle are transferred to the wafer.

The size of the images and features within the images transferred onto the wafer from the reticle are extremely small. Accordingly, the precise positioning of the wafer and the reticle relative to the optical device is critical to the manufacture of high density, semiconductor wafers.

One way to improve the accuracy of the exposure apparatus includes improving the determination of the location of the chip alignment marks relative to the wafer stage and the measurement system. For example, the alignment and determination of the chip alignment marks can be improved by (i) initially aligning and determining the position of the chip alignment marks in a first position with the alignment device, and (ii) subsequently, rotating the wafer 180 degrees to a rotated second position, and (iii) aligning and determining the position of the chip alignment marks in the second position with the alignment device. With this information, the errors in the alignment device can be averaged. Next, the wafer is rotated back to the first position and then the wafer is moved to the operational area.

Unfortunately, rotation of the wafer between the positions can deform the wafer. The deformation of the wafer compromises the accuracy of the alignment process. Further, the wafer holder and the wafer can vibrate and distort during processing. Ultimately, this reduces the accuracy of positioning of the wafer relative to the reticle and degrades the accuracy of the exposure apparatus.

In light of the above, there is a need for a stage assembly and method for precisely positioning a device. Further, there is a need for an exposure apparatus that allows for more accurate positioning of the semiconductor wafer relative to the reticle. Furthermore, there is a need for an exposure apparatus capable of manufacturing precision devices such as high density, semiconductor wafers.

### SUMMARY

The present invention is directed to a stage assembly for positioning a device. The stage assembly includes a device table, a device holder that retains the device, and a lock assembly. The device holder is movable relative to the device table. For example, the device holder can selectively rotate relative to the device table between a first position and a second position. In one embodiment, the lock assembly selectively locks the device holder to the device table without significantly distorting the device holder and the device. Further, the lock assembly selectively locks the device holder to the device table without significantly moving the device holder relative to the device table. With this design, the device holder can alternately be kinematically connected to the device table or rigidly connected to the device table.

In one embodiment, the device holder is connected to the device table with a carrier and a holder connector assembly that kinematically connects the device holder to the carrier. In this design, the lock assembly selectively locks the device holder to the device table without significantly deforming the holder connector assembly.

In one embodiment, the carrier is rotatably secured to the device table, and the holder connector assembly kinematically connects the device holder to the carrier so that rotation of the carrier results in rotation of the device holder. With this design, for example, all of the rotating and bearing forces can be applied to the carrier to move the carrier and the device holder without distorting and deforming the device holder and influencing the flatness of the device. In embodiments in which the stage assembly includes the carrier, the lock assembly can also selectively lock the carrier to the device table.

In some embodiments, the lock assembly includes a lock frame that moves relative to the device holder and the device table between a holder locked position in which the device holder is locked to the device table and a holder unlocked position in which the device holder rotates relative to the device table. In one embodiment, the lock assembly extends between the device holder and the device table.

Additionally, the lock assembly can include a first clamp that secures the lock frame to the device holder and a second clamp that secures the lock frame to the device table. Moreover, at least one of the clamps can include a vacuum source that creates a vacuum. In one embodiment, the lock assembly includes a lock support assembly that supports the lock frame relative to the device holder and allows the lock frame to move between the positions.

The present invention is also directed to a stage assembly, an exposure apparatus, a device, a semiconductor wafer, a method for making a stage assembly, a method for making an exposure apparatus, a method for making a device, and a method for making a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side illustration of an exposure apparatus having features of the present invention;

FIG. 2 is a perspective view of a stage assembly having features of the present invention;

FIG. 3A is a top, exploded perspective view of a table assembly having features of the present invention;

FIG. 3B is a bottom, exploded perspective view of the table assembly of FIG. 3A;

FIG. 3C is a side, cut-away view of a portion of the table assembly of FIG. 3A in a holder unlocked position;

FIG. 3D is a side, cut-away view a portion of of the table assembly of FIG. 3A in a holder locked position;

FIG. 4A is a top, exploded perspective view of an alternate embodiment of the table assembly;

FIG. 4B is a bottom, exploded perspective view of the table assembly of FIG. 4A;

FIG. 4C is a side, cut-away view of a portion of the table assembly of FIG. 4A in a holder unlocked position;

FIG. 4D is a side, cut-away view of a portion of the table assembly of FIG. 4A in a holder locked position;

FIG. 5A is a flow chart that outlines a process for manufacturing a device in accordance with the present invention; and

FIG. 5B is a flow chart that outlines device processing in more detail.

### DESCRIPTION

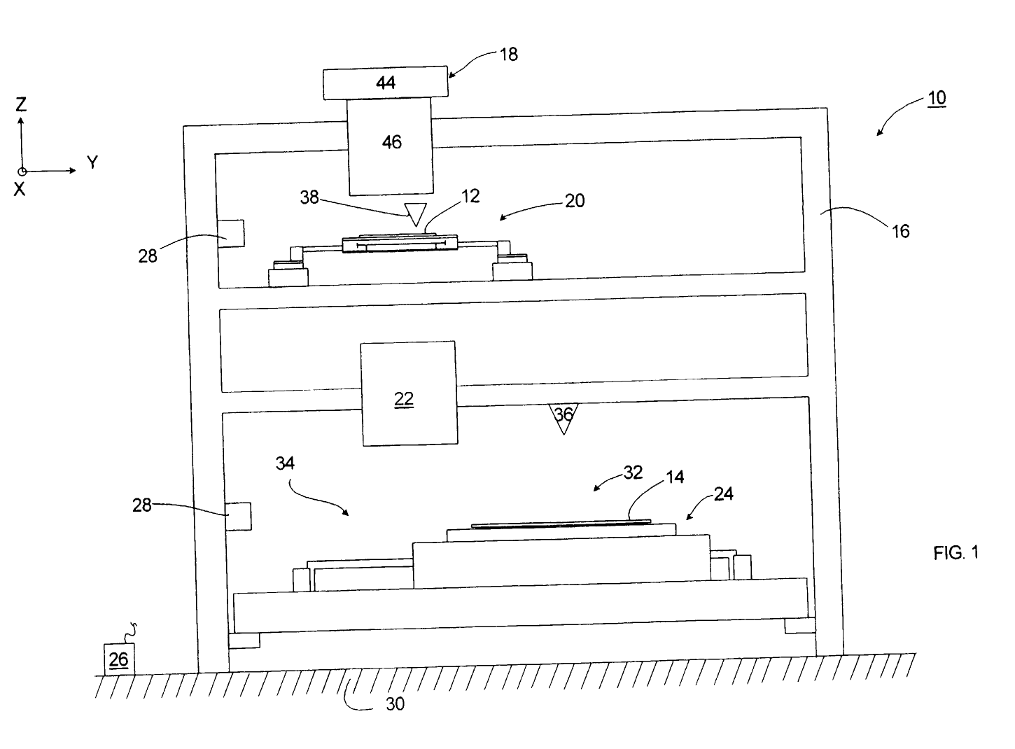

FIG. 1 is a schematic view that illustrates a precision assembly, namely an exposure apparatus 10. The exposure apparatus 10 is particularly useful as a lithographic device that transfers a pattern (not shown) of an integrated circuit from a reticle 12 onto a device, such as a semiconductor wafer 14. In FIG. 1, the exposure apparatus 10 includes an apparatus frame 16, an illumination system 18 (irradiation apparatus), a reticle stage assembly 20, an optical assembly 22 (lens assembly), a wafer stage assembly 24, a control system 26, and a measurement system 28. The exposure apparatus 10 mounts to a mounting base 30, e.g., the ground, a base, or floor or some other supporting structure. The design of the components of the exposure apparatus 10 can be varied to suit the design requirements of the exposure apparatus 10.

As an overview, the wafer stage assembly 24 can move the wafer 14 between an alignment position 32 and an operational position 34. Typically, the wafer 14 includes a plurality of chip alignment marks (not shown) that identify the location of the chips (not shown) on the wafer 14. In the alignment position 32, an alignment device 36, e.g. a microscope, is used to align and determine the position of the wafer alignment marks of the wafer 14 relative to the measurement system 28. During this time, the wafer stage assembly 24 moves the wafer 14 relatively slowly. In the operational position 34, a projection device 38, e.g. a projection microscope, is used to check alignment of the wafer 14 relative to the reticle 12 through the optical assembly 22. Subsequently, in the operational position 34, images from the reticle 12 are transferred to the wafer 14. During image transfer, the wafer stage assembly 24 moves the wafer 14 with rapid accelerations.

As provided herein, in some embodiments, the wafer stage assembly 24 accurately rotates the wafer 14 between a first position, a second position and back to the first position. In these embodiments, the wafer stage assembly 24 includes one or more features that allow wafer 14 to be precisely rotated between the positions and/or moved without influencing the flatness of the wafer 14 and without deflecting and distorting the wafer 14. Stated another way, with the present design, the wafer 14 can be brought back to the same place and the flatness of the wafer 14 is not significantly influenced.

Typically, in the second position, the wafer 14 is rotated 180 degrees relative to the first position. In some embodiments, the wafer 14 can be rotated (i) at least approximately 5 degrees; (ii) at least approximately 25 degrees, (iii) at least approximately 50 degrees, (iv) at least approximately 90 degrees, (v) at least approximately 120 degrees, (vi) at least approximately 180 degrees, and/or (vii) at least approximately 360 degrees.

The alignment device 36 can be used to align and determine the position of the wafer alignment marks of the wafer 14 relative to the measurement system 28 when the wafer 14 is in the first position and subsequently when the wafer 14 is in the second position. As a result thereof, the errors in the alignment device 36 can be averaged. This improves the positioning performance of the exposure apparatus 10. Further, for an exposure apparatus 10, this allows for the manufacturing of higher density, semiconductor wafers 14.

A number of Figures include a coordinate system that illustrates an X axis, a Y axis that is orthogonal to the X axis and a Z axis that is orthogonal to a X and Y axes. It should be noted that the coordinate system can be rotated and/or that these axes can also be referred to as the first, second and third axes.

There are a number of different types of lithographic devices. For example, the exposure apparatus 10 can be used as scanning type photolithography system that exposes the pattern from the reticle 12 onto the wafer 14 with the reticle 12 and the wafer 14 moving synchronously. In a scanning type lithographic device, the reticle 12 is moved perpendicular to an optical axis of the optical assembly 22 by the reticle stage assembly 20 and the wafer 14 is moved perpendicular to the optical axis of the optical assembly 22 by the wafer stage assembly 24. Scanning of the reticle 12 and the wafer 14 occurs while the reticle 12 and the wafer 14 are moving synchronously.

Alternately, the exposure apparatus 10 can be a step-and-repeat type photolithography system that exposes the reticle 12 while the reticle 12 and the wafer 14 are stationary. In the step and repeat process, the wafer 14 is in a constant position relative to the reticle 12 and the optical assembly 22 during the exposure of an individual field. Subsequently, between consecutive exposure steps, the wafer 14 is consecutively moved with the wafer stage assembly 24 perpendicular to the optical axis of the optical assembly 22 so that the next field of the wafer 14 is brought into position relative to the optical assembly 22 and the reticle 12 for exposure. Following this process, the images on the reticle 12 are sequentially exposed onto the fields of the wafer 14 and the next field of the wafer 14 is brought into position relative to the optical assembly 22 and the reticle 12.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly.

The apparatus frame 16 is rigid and supports the components of the exposure apparatus 10. The apparatus frame 16 illustrated in FIG. 1 supports the optical assembly 22, the illumination system 18, and the stage assemblies 20, 24 above the mounting base 30.

The illumination system 18 includes an illumination source 44 and an illumination optical assembly 46. The illumination source 44 emits a beam (irradiation) of light energy. The illumination optical assembly 46 guides the beam of light energy from the illumination source 44 to the optical assembly 22. The beam selectively illuminates different portions of the reticle 12 and exposes the semiconductor wafer 14. In FIG. 1, the illumination source 44 is illustrated as being supported above the reticle stage assembly 20. Typically, however, the illumination source 44 is secured to one of the sides of the apparatus frame 16 and the energy beam from the illumination source 44 is directed to above the reticle stage assembly 20 with the illumination optical assembly 46.

The illumination source 44 can be g-line (436 nm), i-line (365 nm), KrF excimer laser (248 nm), ArF excimer laser (193 nm) and F₂ laser (157 nm). Alternately, the illumination source 44 can also use charged particle beams such as an x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

The optical assembly 22 projects and/or focuses the light passing through the reticle 12 to the wafer 14. Depending upon the design of the exposure apparatus 10, the optical assembly 22 can magnify or reduce the image illuminated on the reticle 12. The optical assembly 22 need not be limited to a reduction system. It could also be a 1× or magnification system.

When far ultra-violet rays such as the excimer laser is used, glass materials such as quartz and fluorite that transmit far ultra-violet rays is preferable to be used in the optical assembly 22. When the F₂ type laser or x-ray is used, the optical assembly 22 should preferably be either catadioptric or refractive (a reticle should also preferably be a reflective type), and when an electron beam is used, electron optics should preferably consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No, 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. patent application No. 873,605 (Application Date: Jun. 6, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 20 holds and positions the reticle 12 relative to the optical assembly 22 and the wafer 14. Similarly, the wafer stage assembly 24 holds and positions the wafer 14 with respect to the projected image of the illuminated portions of the reticle 12 in the operational position 34. The wafer stage assembly 24 is described in more detail below.

Further, in photolithography systems, when linear motors (see U.S. Pat. Nos. 5,623,853 or 5,528,118) are used in the wafer stage or the reticle stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The control system 26 receives information from the measurement system 28 and controls the stage mover assemblies 20, 24 to precisely position the reticle 12 and the wafer 14.

The measurement system 28 monitors movement of the reticle 12 and the wafer 14 relative to the optical assembly 22 or some other reference. With this information, the control system 26 can control the reticle stage assembly 20 to precisely position the reticle 12 and the wafer stage assembly 24 to precisely position the wafer 14. For example, the measurement system 28 can utilize multiple laser interferometers, encoders, and/or other measuring devices.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

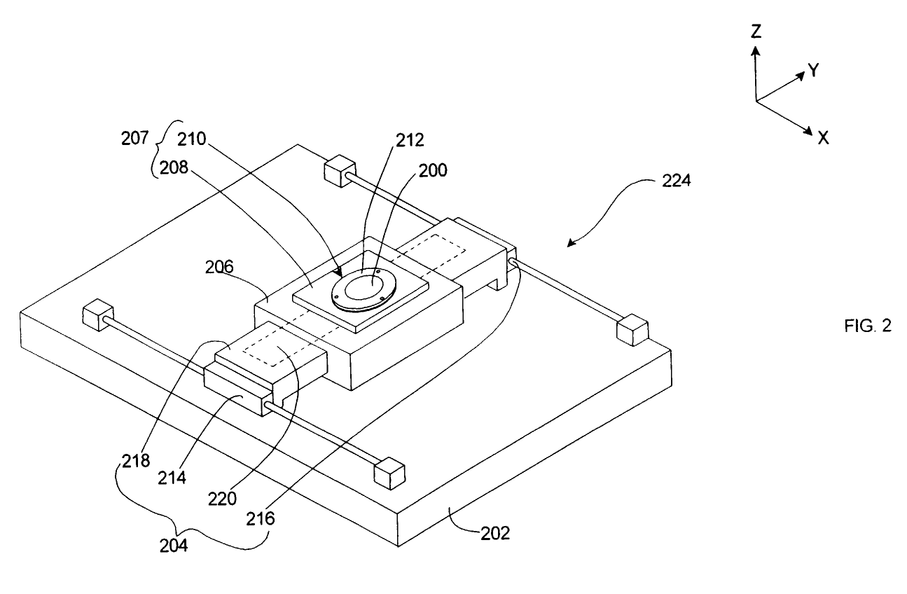

FIG. 2 is a perspective view of a stage assembly 224 that is used to position a device 200. For example, the stage assembly 224 can be used to position a wafer during manufacturing of the semiconductor wafer. Alternately, the stage assembly 224 can be used to move other types of devices 200 during manufacturing and/or inspection, to move a device under an electron microscope (not shown), or to move a device during a precision measurement operation (not shown). For example, the features of the stage assembly 224 illustrated in FIG. 2 can be incorporated into a reticle stage assembly.

The stage assembly 224 includes a stage base 202, a stage mover assembly 204, a stage 206, and a table assembly 207. The table assembly 207 includes a device table 208, and a holder assembly 210 including a device holder 212. In FIG. 2, the device table 208 is moved by the stage mover assembly 204 relative to the stage base 202 along the X axis, along the Y axis, and about the Z axis (collectively “the planar degrees of freedom”). Additionally, the stage mover assembly 204 could be designed to move and position the device table 208 along the Z axis, about the X axis and about the Y axis relative to the stage base 202. Alternately, for example, the stage mover assembly 204 could be designed to move the device table 208 with less than three degrees of freedom.

The design of the components of the stage assembly 224 can be varied to suit design requirements. For example, in FIG. 2, the stage assembly 224 includes one device table 208. Alternately, however, the stage assembly 224 could be designed to include more than one device table 208.

The stage base 202 supports some of the components of the stage assembly 224 above the mounting base 30 (illustrated in FIG. 1). In FIG. 2, the stage base 202 is generally rectangular shaped.

The stage mover assembly 204 controls and moves the stage 206 and the table assembly 207 relative to the stage base 202. In FIG. 2, the stage mover assembly 204 includes a left X stage mover 214, a right X stage mover 216, a guide bar 218, and a Y stage mover 220 (illustrated in phantom). The X stage movers 214, 216 move the guide bar 218, the stage 206 and the table assembly 207 with a relatively large displacement along the X axis and with a limited range of motion about the Z axis, and the Y stage mover 220 moves the stage 206 and the table assembly 207 with a relatively large displacement along the Y axis relative to the guide bar 218.

The design of each stage mover 214, 216, 220 can be varied to suit the movement requirements of the stage assembly 224. For example, each of the stage movers 214, 216, 220 can include one or more rotary motors, voice coil motors, linear motors utilizing a Lorentz force to generate drive force, electromagnetic actuators, or some other force actuators. In the embodiment illustrated in FIG. 2, each of the stage movers 214, 216, 220 is a linear motor.

The guide bar 218 moves the stage 206 along the X axis and about the Z axis and guides the movement of the stage 206 along the Y axis. In FIG. 2, the guide bar 218 is somewhat rectangular beam shaped. A bearing (not shown) maintains the guide bar 218 spaced apart along the Z axis relative to the stage base 202 and allows for motion of the guide bar 218 along the X axis and about the Z axis relative to the stage base 202. The bearing can be a vacuum preload type fluid bearing that maintains the guide bar 218 spaced apart from the stage base 202 in a non-contact manner. Alternately, for example, a magnetic type bearing or a ball bearing type assembly could be utilized that allows for motion of the guide bar 218 relative to the stage base 202.

In FIG. 2, the stage 206 moves with the guide bar 218 along the X axis and about the Z axis and the stage 206 moves along the Y axis relative to the guide bar 218. In this embodiment, the stage 206 is generally rectangular shaped and includes a rectangular shaped opening for receiving the guide bar 218. A bearing (not shown) maintains the stage 206 spaced apart along the Z axis relative to the stage base 202 and allows for motion of the stage 206 along the X axis, along the Y axis and about the Z axis relative to the stage base 202. The bearing can be a vacuum preload type fluid bearing that maintains the stage 206 spaced apart from the stage base 202 in a non-contact manner. Alternately, for example, a magnetic type bearing or a ball bearing type assembly could be utilized that allows for motion of the stage 206 relative to the stage base 202.

Further, the stage 206 is maintained apart from the guide bar 218 with opposed bearings (not shown) that allow for motion of the stage 206 along the Y axis relative to the guide bar 218, while inhibiting motion of the stage 206 relative to the guide bar 218 along the X axis and about the Z axis. Each bearing can be a fluid bearing that maintains the stage 206 spaced apart from the guide bar 218 in a non-contact manner. Alternately, for example, a magnetic type bearing or a ball bearing type assembly could be utilized that allows for motion of the stage 206 relative to the guide bar 218.

In the embodiment illustrated in the FIG. 2, the device table 208 is generally rectangular plate shaped. Further, the device table 208 is fixedly secured to the stage 206 and moves concurrently with the stage 206. Alternately, for example, the stage mover assembly 204 can include a table mover assembly (not shown) that moves and adjusts the position of the device table 208 relative to the stage 206. For example, the table mover assembly can adjust the position of the device table 208 relative to the stage 206 with six degrees of freedom. Alternately, for example, the table mover assembly can be designed to move the device table 208 relative to the stage 206 with only three degrees of freedom. The table mover assembly can include one or more rotary motors, voice coil motors, linear motors, electromagnetic actuators, or other type of actuators.

The holder assembly 210 allows for the accurate rotation and/or movement of the device holder 212 and the device 200 while inhibiting deformation of the device holder 212 and the device 200. For example, the device holder 212 selectively rotates relative to the device table 208 between a first position and a second position. Further, the holder assembly 210 selectively securely clamps the device holder 212 and the device 200 to the device table 208 while inhibiting deformation of the device holder 212 and the device 200. As a result thereof, the vibration of the device holder 212 and the device 200 is reduced during high acceleration movements of the device table 208 and the device holder 212.

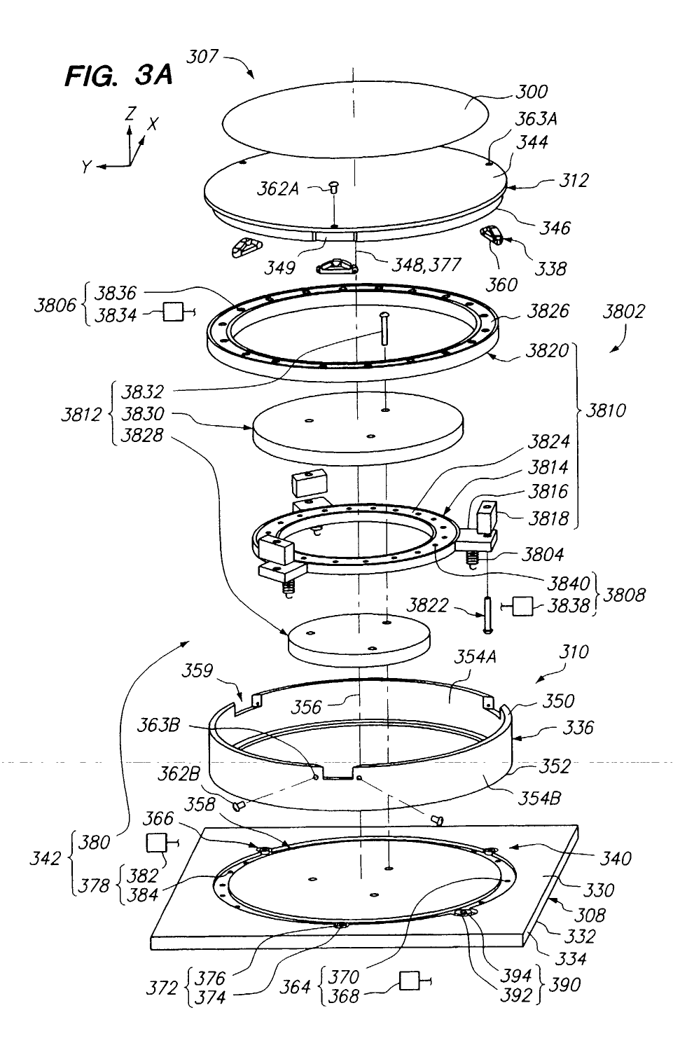

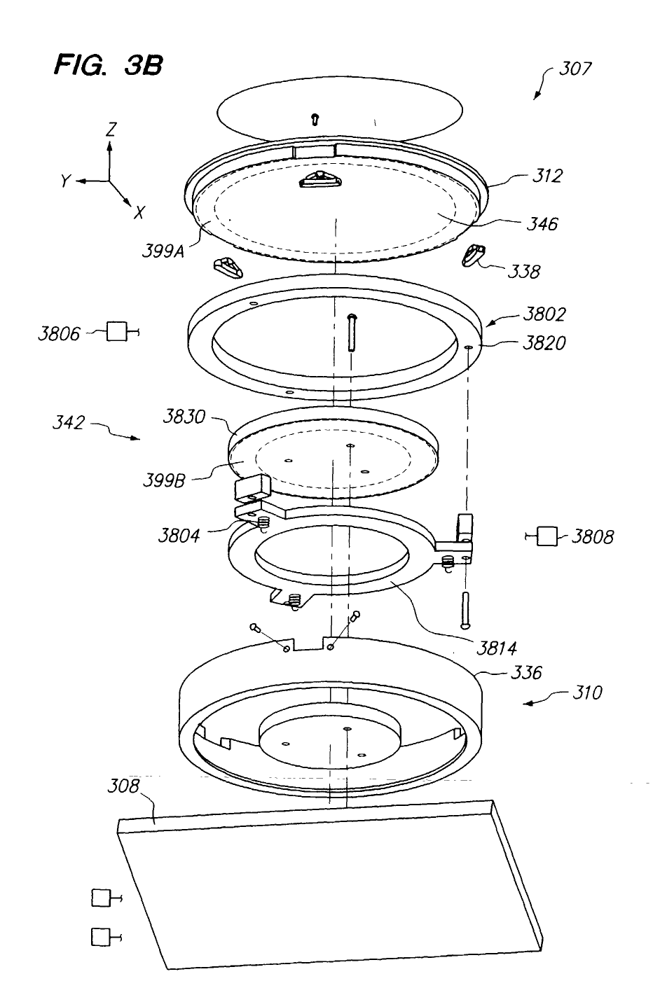

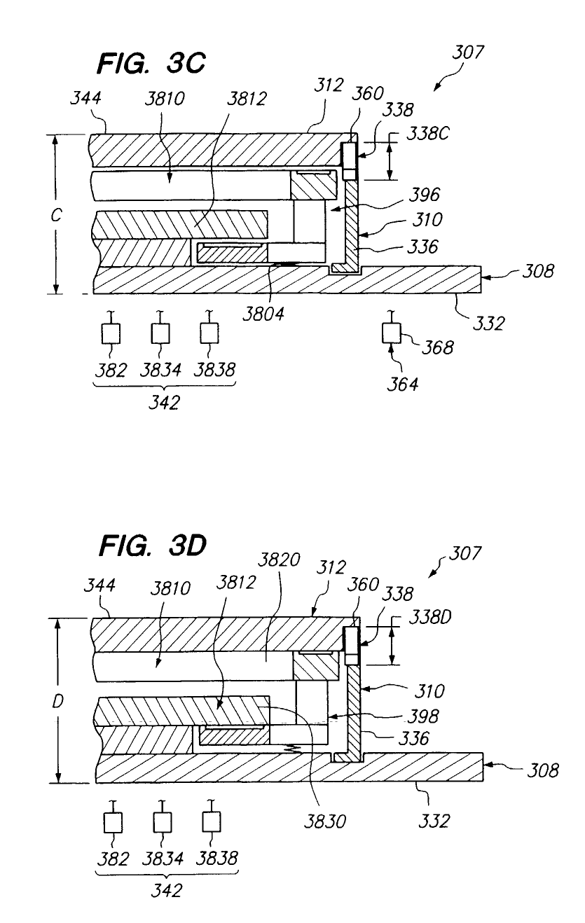

FIG. 3A illustrates an exploded perspective view of one embodiment of a table assembly 307 having a device table 308 and a holder assembly 310 including a device holder 312. The table assembly 307 can be used in the stage assembly 224 of FIG. 2 and the exposure apparatus 10 of FIG. 1. In this embodiment, the device holder 312 is at alternate times (i) kinematically supported relative to the device table 308 and (ii) fixedly clamped to the device table 308. As a result of this design, (i) during calibration of the alignment system, the device holder 312 and the device 300 can be supported kinematically, and (ii) during alignment and exposure processing of the device 300, the device holder 312 and the device 300 can be clamped to the device table 308.

During calibration of the alignment system of a wafer, relatively high accelerations of the device table 308 are not required. Thus, the device holder 312 can be flexibly supported without the device holder 312 being subjected to significant vibration. Alternately, during exposure, relatively high accelerations of the table assembly 307 are necessary to expedite processing. At this time, the device holder 312 can be clamped to the device table 308 to reduce vibration of the device holder 312. Alternately, the stiffness and size of the kinematic supports and the device holder 312 would have to be increased.

In this embodiment, the device table 308 includes a table top 330, an opposed table bottom 332, and four table sides 334. The table bottom 332 is secured to the stage 206 (illustrated in FIG. 2).

The holder assembly 310 supports the device 300. In some embodiments, the holder assembly 310 allows for the rotation of the device 300. In the embodiment illustrated in FIG. 3A, the holder assembly 310 includes the device holder 312, a carrier 336, a holder connector assembly 338, a rotation assembly 340, and a lock assembly 342. The design of each of the components can be varied pursuant to the teachings provided. Alternately, the holder assembly 310 can be designed without the carrier.

The device holder 312 retains the device 300. The device holder 312 can include a vacuum chuck, an electrostatic chuck, or some other type of clamp. In the embodiment illustrated in FIG. 3A, the device holder 312 is generally disk shaped and includes a holder top 344, a holder bottom 346, and a holder central axis 348. The holder bottom 346 is generally flat disk shaped and includes three spaced apart flexure recesses 349 (only one is shown in FIG. 3A) for receiving a portion of the holder connector assembly 338. In FIG. 3A, the diameter of the device holder 312 at the holder top 344 is greater than the diameter at the holder bottom 346.

The carrier 336 supports the device holder 312 and facilitates rotation and/or movement of the device holder 312 and the device 300 without deforming the device holder 312 and the device 300. With this design, when the carrier 336 distorts, the device holder 312 moves, but because of the holder connector assembly 338, the device holder 312 does not significantly deform. As a result thereof, the device holder 312 can be rotated and/or moved without significantly deforming the device holder 312.

In the embodiment illustrated in FIG. 3A, the carrier 336 is somewhat concentric with the device holder 312 and is positioned somewhat between the device table 308 and the device holder 312. Further, the carrier 336 is generally tubular or annular ring shaped and includes a carrier top 350, a carrier bottom 352, an inner diameter surface 354A, an outer diameter 354B, and a carrier central axis 356. The carrier 336 supports the device holder 312 near a perimeter of the device holder 312.

Additionally, the table assembly 307 can include a carrier recess 358 for receiving at least a portion of the carrier 336. The carrier recess 358 allows for the use of the carrier 336 in the table assembly 307 without significantly increasing the footprint of the table assembly 307 over table assemblies that do not include the carrier 336. The size and shape of the carrier recess 358 can be varied. As provided herein, the carrier recess 358 can be in the table top 330 of the device table 308. In FIG. 3A, the carrier recess 358 is an annular shaped channel in the table top 330. Further, the outer perimeter of the device holder 312 is partly recessed to fit within a portion of the carrier 336.

Alternately, for example, the table assembly 307 could be designed without the carrier recess 358 if the carrier 336 is concentric with the device holder 312 and has a larger diameter than the device holder 312.

Moreover, in the embodiment illustrated in FIG. 3A, the carrier 336 includes three, spaced apart connector recesses 359 for receiving at least a portion of the holder connector assembly 338. The connector recesses 359 allow for the use of the carrier 336 and the holder connector assembly 338 in the table assembly 307 without significantly increasing the footprint of the table assembly 307 over table assemblies that do not include the carrier 336 and the holder connector assembly 338. In FIG. 3A, each connector recess 359 is an arch shaped notch.

The holder connector assembly 338 mechanically and flexibly connects the device holder 312 to the carrier 336. As a result thereof, movement of the carrier 336 results in movement of the device holder 312. The design of the holder connector assembly 338 can be varied. In the embodiments illustrated herein, the holder connector assembly 338 substantially kinematically connects the device holder 312 to the carrier 336. With this design, deformation of the carrier 336 does not result in deformation of the device holder 312 or the device 300. Alternately, for example, the holder connector assembly 338 can connect the device holder 312 to the carrier 336 in a flexible, non-kinematic manner.

In FIG. 3A, the holder connector assembly 338 includes three spaced apart flexures 360 that extend between the device holder 312 and the carrier 336. As used herein, the term “flexure” shall mean a part that has relatively high stiffness in some directions and relatively low stiffness in other directions. The flexure 360 has (i) a relatively high stiffness along the Z axis and in the tangential direction and (ii) is relatively flexible in the radial direction and about the X, Y and Z axes. The ratio of relatively high stiffness to relatively low stiffness is preferably at least approximately 100/1, and can be at least approximately 1000/1. In FIG. 3A, the flexures 360 provide three points of contact between the device holder 312 and the carrier 336 and restrain movement of the device holder 312 relative to the carrier 336 along the X axis, the Y axis and the Z axis and about the X axis, the Y axis and the Z axis.

In FIG. 3A, each flexure 360 is a generally triangular shaped and includes (i) a generally flat flexure bottom that fits within one connector recess 359 and is secured to the carrier 336, (ii) a generally flat flexure top that fits within one flexure recess 349 and is secured to the device holder 312, and (iii) a pair of spaced apart flexure sides that converge together and extend between the flexure bottom and the flexure top. Each of the flexure sides includes a relatively rigid, stiff section positioned between a pair of relatively resilient, flexible sections. The length and rigidity of the stiff section and the length and resiliency of the flexible sections can be varied to adjust the overall stiffness of each flexure 360. It should be noted that other embodiments of the holder connector assembly 338 are possible. More specifically, the flexures can be replaced with another type of kinematic support.

It should also be noted that in FIG. 3A, that the flexures 360 directly connect, couple and extend between the device holder 312 and the carrier 336. Further, the top of each flexure 360 can be secured to the device holder 312 with a first fastener 362A that extends through a holder aperture 363A and the bottom of each flexure 360 can be secured to the carrier 336 with a pair of second fasteners 362B that extend through carrier apertures 363B.

The rotation assembly 340 allows for the rotation of the device 300 relative to the device table 308. In FIG. 3A, the rotation assembly 340 allows for the rotation of the carrier 336 about the carrier central axis 356. Further, in this embodiment, (i) the holder central axis 348, the carrier central axis 356 and the holder axis of rotation 377 are coaxial, (ii) the device holder 312 rotates about the holder central axis 348 and (iii) the carrier 336 rotates about the carrier central axis 356. The design of the rotation assembly 340 can be varied. In FIG. 3A, the rotation assembly 340 includes a lifting bearing assembly 364 and a guiding bearing assembly 366.

The lifting bearing assembly 364 selectively lifts the carrier 336 away from the device table 308. In this embodiment, the lifting bearing assembly 364 includes a bearing fluid source 368 and one or more fluid outlets 370. The fluid source 368 provides pressurized fluid, e.g. air, to the fluid outlets 370. When fluid is released from the fluid outlets 370, a fluid bearing is created-that lifts the carrier 336 and allows for rotation of the carrier 336 and the device holder 312 about the Z axis relative to the device table 308. The fluid outlets 370 can be in the device table 308 and directed towards the carrier 336 and/or in the carrier 336 and directed towards the device table 308. In FIG. 3A, the fluid outlets 370 are in the carrier recess 358 of the device table 308.

The guiding bearing assembly 366 guides the movement and/or rotation of the carrier 336 relative to the device table 308. In this embodiment, the guiding bearing assembly 366 includes three spaced apart mechanical roller type bearing assemblies 372. Each roller type bearing assembly 372 includes a bearing shaft 374 that is secured to the device table 308 and a roller bearing 376 that is secured to the bearing shaft 374. An outer race of the roller bearing 376 rotates relative to the bearing shaft 374. In FIG. 3A, the outer race engages the outer diameter surface 354B of the carrier 336. With this design, the roller bearing assemblies 372 cooperate to guide the rotation of the carrier 336. It should be noted that one of the shafts 374 is secured to the device table 308 in a manner that allows the shaft 374 to move slightly relative to the device table 308. This feature allows the roller bearing assemblies 372 to accommodate inaccuracies in the shape of the carrier 336.

Alternately, for example, the guide bearing assembly could be a fluid type bearing that supports the carrier 336 relative to the device table 308 in a non-contact fashion. Alternately, for example, the rotation assembly 340 can include a magnetic type bearing or other type of bearings that allows for motion of the carrier 336 relative to the device table 308.

The lock assembly 342 selectively locks the device holder 312 to the device table 308. The design of the lock assembly 342 can vary. In some of the embodiment provided herein, the lock assembly 342 selectively locks the device holder 312 to the device table 308 (i) without significantly distorting and deforming the device holder 312 and the device 300, (ii) without significantly moving the device holder 312 relative to the device table 308, and/or (iii) without significantly deforming and distorting the holder connector assembly 338.

In FIG. 3A, the lock assembly 342 includes a carrier lock 378 and a holder lock 380. In FIG. 3A, the carrier lock 378 selectively clamps the carrier 336 to the device table 308 and the holder lock 380 selectively clamps the device holder 312 to the device table 308. Alternately, the lock assembly 342 could be designed without the carrier lock 378. Still alternately, for example, if the table assembly does not include a carrier, the lock assembly 342 does not include a carrier lock.

In FIG. 3A, the carrier lock 378 includes a vacuum source 382 and one or more fluid inlets 384. The vacuum source 382 creates a vacuum at the fluid inlets 384. When the lifting fluid bearing 364 is not activated, the vacuum pulls the carrier bottom 352 of the carrier 336 against the device table 308 and maintains the carrier 336 against the device table 308. The vacuum source 382 can be turned off when the lifting fluid bearing 364 is activated. Alternately, the vacuum source 382 can be used in conjunction with the lifting fluid bearing 364 to create a vacuum preload type fluid bearing. The vacuum in the fluid inlets 384 clamps the carrier 336 to the device table 308 to inhibit relative motion between the carrier 336 and the device table 308. The fluid inlets 384 can be in the device table 308 and directed towards the carrier 336 and/or in the carrier 336 and directed towards the device table 308. In FIG. 3A, the fluid inlets 384 are in the carrier recess 358 of the device table 308.

It should be noted that the carrier lock 378 can include another type of mechanism that locks the carrier 336 to the device table 308. The mechanism should preferably be a type that does not generate significant heat near the device holder 312 and is not too heavy.

The holder lock 380 selectively clamps and secures the device holder 312 to the device table 308 to selectively inhibit rotation and movement of the device holder 312 and the device 300 relative to the device table 308. The design of the holder lock 380 can be varied. In FIG. 3A, the holder lock 380 includes a frame assembly 3802, a lock support assembly 3804, a first clamp 3806 and a second clamp 3808. The design of these components can be varied.

In FIG. 3A, the frame assembly 3802 includes a lock frame 3810 and a base frame 3812. The lock frame 3810 moves relative to the base frame 3812, the device holder 312 and the device table 308 between a holder locked position 398 (illustrated in FIG. 3D) in which the device holder 312 is locked to the device table 308 and a holder unlocked position 396 (illustrated in FIG. 3C) in which the device holder 312 in not locked to the device table 308. In FIG. 3A, the lock frame 3810 includes (i) a first section 3814 that is generally annular disk shaped, (ii) three spaced apart fingers 3816 that extend radially outward from the first section 3814, (iii) three base spacers 3818 that extend upward from the fingers 3816, (iv) a second section 3820 that is generally annular disk shaped, and (v) a fastener assembly 3822 (only a portion of which is illustrated in FIG. 3A) that secures the second section 3820 and the spacers 3818 to the first section 3814. In this embodiment, the lock frame 3810 includes a first vacuum surface 3824 and a spaced apart second vacuum surface 3826. In FIG. 3A, the first vacuum surface 3824 is located at the top of the first section 3814, and (ii) the second vacuum surface 3826 is located at the top of the second section 3820. Further, each vacuum surface 3824, 3826 is generally annular shaped, polished, smooth and faces upward. Moreover, each vacuum surface 3824, 3826 includes an inner diameter lip and an outer diameter lip.

In FIG. 3A, the base frame 3812 is fixedly secured to the device table 308. More specifically, the base frame 3812 includes a disk shaped spacer 3828 that is positioned adjacent to the device table 308, a disk shaped stop 3830 and a fastener assembly 3832 (only a portion of which is illustrated in FIG. 3A) that secures the stop 3830 and the spacer 3828 to the table top 330 of the device table 308.

The lock support assembly 3804 supports and mechanically and flexibly connects the lock frame 3810 to the device table 308 and allows the lock frame 3810 to move between the positions 396, 398. The design of the lock support assembly 3804 can be varied. In FIG. 3A, the lock support assembly 3804 includes three spaced apart resilient members that extend between the lock frame 3810 and the device table 308. The resilient members allow the lock frame 3810 to move relative to the device holder 312 along the Z axis. Each resilient member can be a spring or a piece of resilient material such as rubber. Alternately, the lock support assembly 3804 could include one or more flexures, or a vacuum clamp to lock the lock assembly to the table.

In an alternate embodiment, the lock support assembly 3804 could extend between the lock frame 3810 and the device holder 312. In still another alternate embodiment, the lock support assembly 3804 could support the lock frame 3810 relative to the carrier 336. In this design, the resilient members extend between the carrier 336 and the lock frame 3810.

The first clamp 3806 secures the lock frame 3810 to the device holder 312. Somewhat similarly, the second clamp 3808 secures the lock frame 3810 to the base frame 3812 and thereby the device table 308. The design of the clamps 3806, 3808 can be varied. In FIG. 3A, the first clamp 3806 includes a first vacuum source 3834, and a plurality of spaced apart, first inlets 3836. The first vacuum source 3834, when activated, creates a vacuum in the first inlets 3836 to pull the lock frame 3810 against the bottom of the device holder 312 and lock the lock frame 3810 against the device holder 312. The vacuum clamps the lock frame 3810 to the device holder 312 to inhibit relative movement between the device holder 312 and the device table 308. The first vacuum source 3834 can be a vacuum pump.

The first inlets 3836 can be in the lock frame 3810 and directed towards the bottom of the device holder 312. Alternately, for example, the first inlets 3836 can be the bottom of the device holder 312 and directed towards the lock frame 3810. In FIG. 3A, the first inlets 3836 are in the second section 3820 of the lock frame 3810.

The second clamp 3808 includes a second vacuum source 3838, and a plurality of spaced apart, second inlets 3840. The second vacuum source 3838, when activated, creates a vacuum in the second inlets 3840 to pull the lock frame 3810 against the base frame 3812 and lock the lock frame 3810 against the base frame 3812. The vacuum clamps the lock frame 3810 to the base frame 3812 to inhibit relative movement between the device holder 312 and the device table 308. The second vacuum=source 3838 can be a vacuum pump.

It should be noted that in FIG. 3A, the second vacuum source 3838 is illustrated as being separate from the first vacuum source 3834. Alternately, a single vacuum source can be used or more than two vacuum sources can be utilized.

The second inlets 3840 can be in the lock frame 3810 and directed towards the base frame 3812. Alternately, for example, the second inlets 3840 can be in the base frame 3812 and directed towards the lock frame 3810. In FIG. 3A, the second inlets 3840 are in the first section 3814 of the lock frame 3810.

It should be noted that the first clamp 3806 and/or the second clamp 3808 can include another type of mechanism that locks the lock frame 3810. The mechanism should preferably be a type that does not generate significant heat.

In some embodiments, the table assembly 307 can include a holder mover 390 that accurately moves and/or rotates the device holder 312 relative to the device table 308. The design of the holder mover 390 can be varied to suit the design requirements of the rest of the stage assembly. In FIG. 3A, the holder mover 390 includes a motor 392 and an output wheel 394. The type of motor 392 can be a rotary motor, an electromagnetic actuator, or other type of actuator. In FIG. 3A, the motor 392 is a rotary type motor that rotates the output wheel 394. The motor 392 is secured to the device table 308. The output wheel 394 engages a portion, e.g. the outer perimeter the carrier 336.

Additionally, the holder mover 390 can include a motor damper (not shown) that secures the motor 392 to the device table 308. The motor damper inhibits and dampens the reaction forces generated by the motor 392 from being transferred to the device table 308. The motor damper 396 can include a reaction mass assembly, a fluid cylinder, resilient material such as a viscoelastic material, or other type of vibration damping device. Alternately, for example, the motor 392 could be secured directly to the device table 308.

Still alternately, other types of holder movers 390 can be utilized to move and/or-rotate the device holder 312 relative to the device table 308. For example, the motor could be secured to the stage or to the apparatus frame. Alternately, the table assembly 307 could include a stop (not shown) that selectively retains a point of the device holder 312. In this embodiment, with the stop inhibiting a point of the device holder 312 from moving, the stage mover assembly 204 moves the device table 308 in a semicircular pattern and the device holder 312 is rotated between the positions about the stop and about the holder axis of rotation 377. In another embodiment, a center of gravity of the device holder 312 and/or the carrier 336 is offset and positioned away from the holder axis of rotation 377. With this configuration, the stage mover assembly can be used to accelerate the device table 308 and rotate the device holder 312. Further, in this embodiment, the stage mover assembly can be used to accelerate the device table 308 and stop rotation of the device holder 312.

In yet another embodiment, the motor includes a first component (not shown) and an adjacent second component (not shown) that interacts with the first component. One of the components includes one or more magnet arrays and the other component includes one or more conductor arrays. For the motor, electrical current supplied to the conductor array interacts with a magnetic field generated by the magnet array. This causes a force (Lorentz type force) between the conductor array and the magnet array that can be used to move the device holder relative to the device table between the positions. As provided herein, the second component is secured to the carrier 336 and/or the device holder 312. Further, the first component is secured to a somewhat rigid structure, such as the apparatus frame, the device table, or the stage.

Additionally, U.S. application Ser. No. 09/997,553, filed on Nov. 29, 2001 contains a number of other suitable holder movers that can be used with the present invention. As far as permitted, the contents of U.S. application Ser. No. 09/997,553 are incorporated herein by reference.

It should be noted that the invention can be used to minimize deformation of the device holder 312 and the device 300 even if rotation is not required. Further, the table assembly 307 could be designed without the carrier 336. In this design, the holder connector assembly 338 would extend directly between the device holder 312 and the device table 308.

FIG. 3B illustrates a bottom perspective view of the table assembly 307, including the device table 308, and the holder assembly 310 including the device holder 312, the carrier 336, the holder connector assembly 338, and the lock assembly 342 including the frame assembly 3802, the lock support assembly 3804, the first clamp 3806, and the second clamp 3808 of FIG. 3A. It should be noted that in FIG. 3B, (i) the holder bottom 346 includes an annular shaped polished region 399A (illustrated as dashed lines) to facilitate the vacuum lock between the device holder 312 and the second section 3820, and (ii) the bottom of the stop 3830 includes an annular shaped polished region 399B to facilitate the vacuum lock between the stop 3830 and the first section 3814. Alternately, each polished region 399A, 399B can have a different shape.

FIG. 3C is a cross-sectional view of a potion of the table assembly 307 of FIG. 3A including the device table 308, and the holder assembly 310 including the device holder 312, the carrier 336, the holder connector assembly 338, and the lock assembly 342, with the vacuum sources 382, 3834, 3838 of the lock assembly 342 switched off and the bearing fluid source 368 of the lifting bearing assembly 364 switched on, causing the carrier 336 to be spaced apart and in a carrier unlocked position from the device table 308 and the lock frame 3810 to be in an unlocked position 396 spaced apart from the device holder 312. At this time, the lock support assembly 3804 supports and maintains the lock frame 3810 spaced apart from the base frame 3812 and the device holder 312. In this position, the device holder 312 is free to move with carrier 336 relative to the device table 308.

In FIG. 3C, the flexure 360 has a flexure height 338C and the distance between the holder top 344 and the table bottom 332 is equal to “C.”

FIG. 3D is a cross-sectional view of a portion of the table assembly 307 of FIG. 3A including the device table 308, and the holder assembly 310 including the device holder 312, the carrier 336, the holder connector assembly 338, and the lock assembly 342, with the vacuum sources 382, 3834, 3838 of the lock assembly 342 activated and maintaining the lock frame 3810 in the locked position 398 and the device holder 312 locked to the device table 308.

In this design, the vacuum source 382 of the lock assembly 342 pulls the carrier 336 against the device table 308 into a carrier locked position. Further, the vacuum source 3834 pulls the second section 3820 of the lock frame 3810 against the device holder 312 and the vacuum source 3838 pulls the first section 3814 of the lock frame 3810 against the stop 3830 of the base frame 3812. Before exposing wafers, the device holder 312 is clamped to device table 308 to increase the stiffness of the device holder 312. This minimizes vibration of the device holder 312 and the device 300 during movement of the device table 308. As a result, the stiffness and size of the carrier 336, the device holder 312 and the holder connector assembly 338 can be reduced.

In FIG. 3D, the flexure 360 has a flexure height 338D and the distance between the holder top 344 and the table bottom 332 is equal to “D.”

Referring to FIGS. 3C and 3D, it should be noted that in this embodiment, the device holder 312 is maintained in approximately the same position when in the locked position 398 (FIG. 3D) and the unlocked position 396 (FIG. 3C). Further, the lock frame 3810 moves relative to the device holder 312. As a result thereof, the flexures 360 of the holder connector assembly 338 are not compressed during movement between the unlocked position 396 and the locked position 398. This inhibits deformation of the device holder 312 and the device 300 (illustrated in FIG. 3A).

For example, the difference in deformation of device holder 312 when the device holder 312 is locked and unlocked is between approximately 1 and 100 nm. Further, the difference in the flexure height 338D of the flexure 360 when the device holder 312 is locked and the flexure height 338C when the device holder 312 is unlocked is less than approximately 5 microns. Further, the amount of movement of the device holder 312 along the Z axis between the locked 398 and unlocked position 396 is less than approximately 1 micron, or 5 micron, or 20 micron. Stated another way, the change in the distance “D” between the holder top 360 and the table bottom 332 in the locked position 398 and the distance “C” between the holder top 360 and the table bottom 332 in the unlocked position 396 is less than approximately 1 micron or 5 micron.

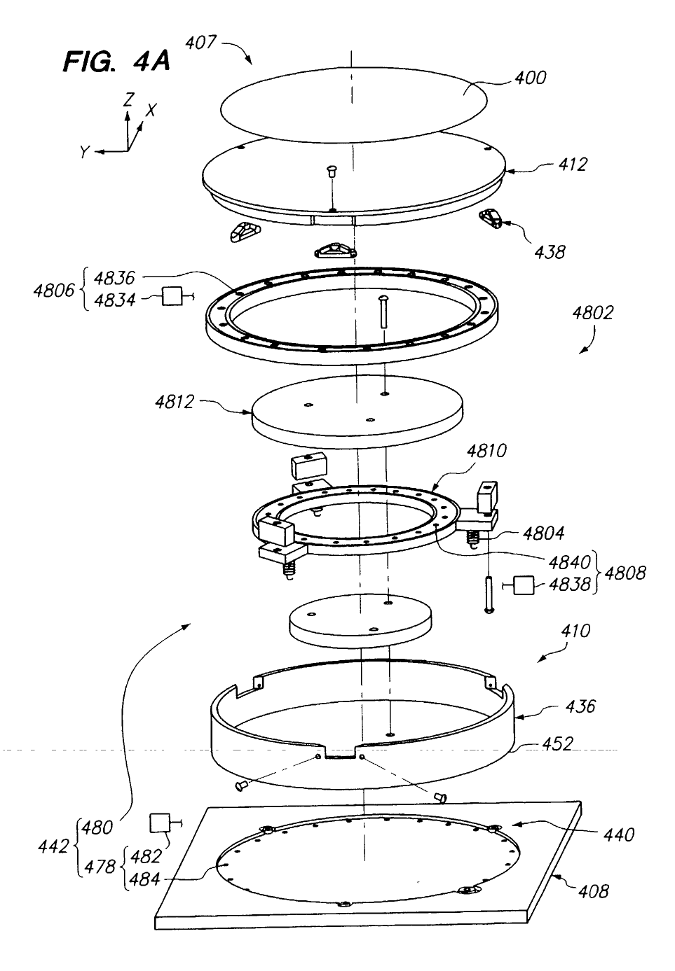

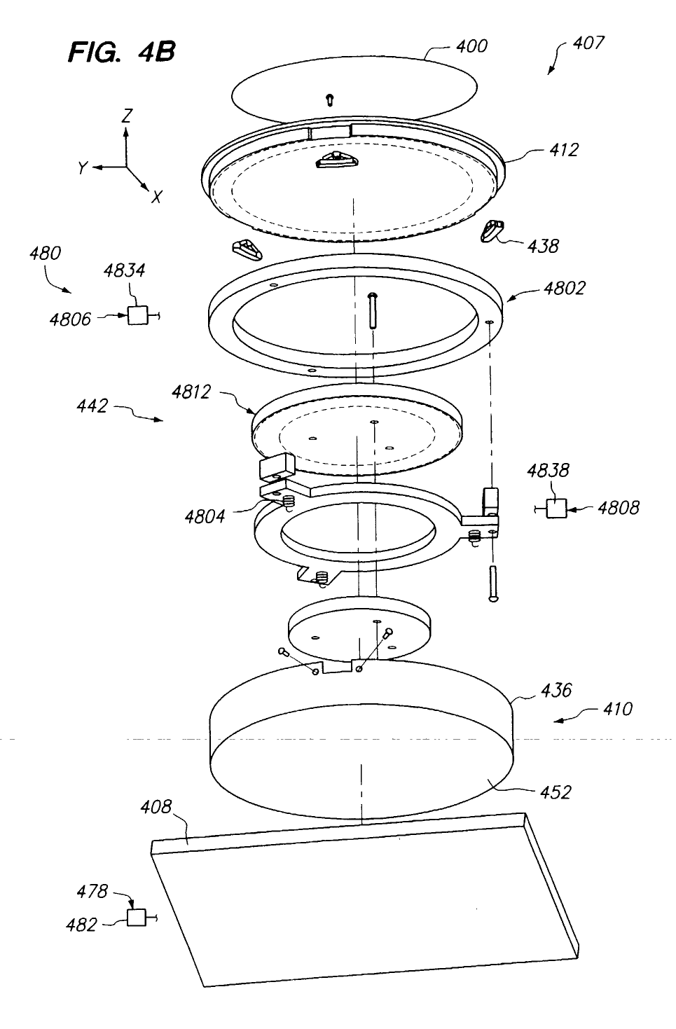

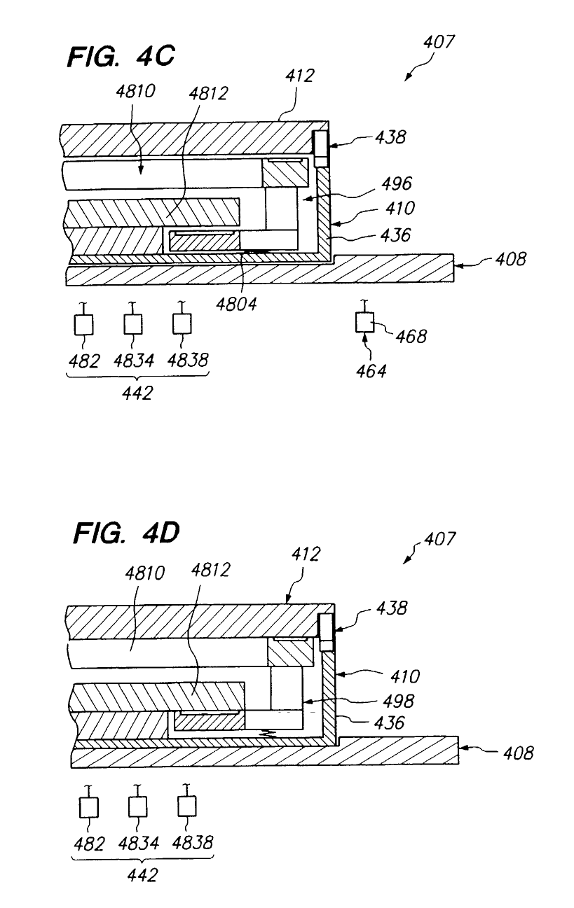

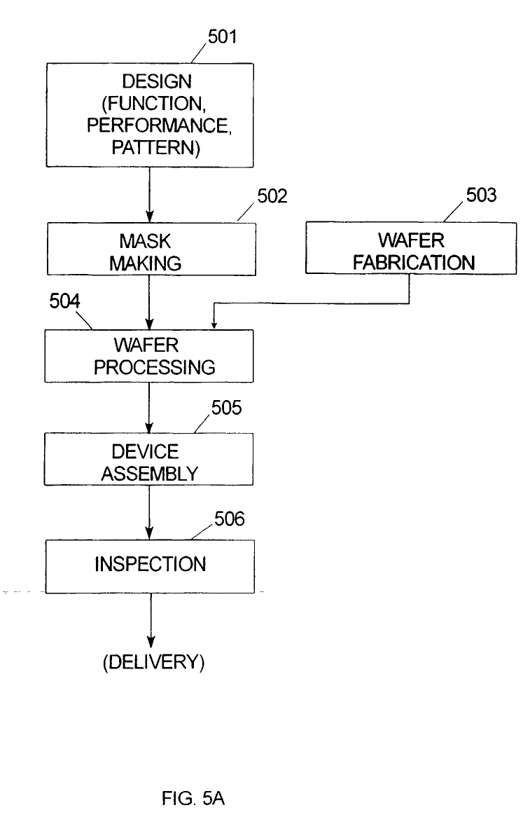

FIGS. 4A and 4B are exploded perspective views of another embodiment of a table assembly 407 including a device table 408, and a holder assembly 410 including a device holder 412, a carrier 436, a holder connector assembly 438, a rotation assembly 440 and a lock assembly 442 that are somewhat similar to the corresponding components described above and illustrated in FIG. 3A.

However, the carrier 436 and the lock assembly 442 are slightly different in this embodiment. More specifically, in this embodiment, the carrier bottom 452 of the carrier 436 is disk shaped. Further, the base frame 4812 is fixedly secured to the carrier 436 instead of the device table 408.

In this embodiment, the lock assembly 442 selectively locks the device holder 412 to the carrier 436 (i) without significantly distorting the device holder 412 and the device 400, (ii) without significantly moving the device holder 412 relative to the device table 408, and/or (iii) without significantly deforming the holder connector assembly 438. In FIGS. 4A and 4B, the lock assembly 442 includes a carrier lock 478 and a holder lock 480 that are somewhat similar to the corresponding components described above. In FIGS. 4A and 4B, the carrier lock 478 selectively clamps the carrier 436 to the device table 408 and the holder lock 480 selectively clamps the device holder 412 to the carrier 436.

In FIGS. 4A and 4B, the carrier lock 478 includes a vacuum source 482 that draws a vacuum in fluid inlets 484 to pull the carrier bottom 452 of the carrier 436 against the device table 408.

The holder lock 480 selectively clamps and secures the device holder 412 to the carrier 436. In FIGS. 4A and 4B, the holder lock 480 includes a frame assembly 4802, a lock support assembly 4804, a first clamp 4806 and a second clamp 4808 that are similar to the corresponding components described above and illustrated in FIG. 3A. However, in FIGS. 4A and 4B, the base frame 4812 is fixedly secured to the carrier 436. Further, the lock support assembly 4804 supports and mechanically and flexibly connects the lock frame 4810 relative to the carrier 436 and allows the lock frame 4810 to move between the locked and unlocked positions. The first vacuum source 4834, when activated, creates a vacuum in the first inlets 4836 to pull the lock frame 4810 against the bottom of the device holder 412.

The second vacuum source 4838, when activated, creates a vacuum in the second inlets 4840 to pull the lock frame 4810 against the base frame 4812 and lock the lock frame 4810 against the base frame 4812.

FIG. 4C is a cross-sectional view of the table assembly 407 of FIG. 4A including the device table 408, and the holder assembly 410 including the device holder 412, the carrier 436, the holder connector assembly 438, and the lock assembly 442, with the vacuum sources 482, 4834, 4838 of the lock assembly 442 switched off and the bearing fluid source 468 of the lifting bearing assembly 464 switched on, causing the carrier 436 to be spaced apart from the device table 408 and the lock frame 4810 to be in an unlocked position 496 spaced apart from the device table 408. At this time, the lock support assembly 4804 supports the lock frame 4810 spaced apart from the base frame 4812 and the carrier 436.

FIG. 4D is a cross-sectional view of the table assembly 407 of FIG. 4A including the device table 408, and the holder assembly 410 including the device holder 412, the carrier 436, the holder connector assembly 438, and the lock assembly 442, with the vacuum sources 482, 4834, 4838 of the lock assembly 442 maintaining the lock frame 4810 in the locked position 498.

In this design, the vacuum source 4834 of the lock assembly 442 tightly pulls the lock frame 4810 against the device holder 412 and the vacuum source 4838 pulls the frame 4810 against the base frame 4812. Further, the vacuum source 482 of the lock assembly 442 pulls the carrier 436 against the device table 408. This minimizes vibration of the device holder 412 and the device 400 during movement of the device table 408.

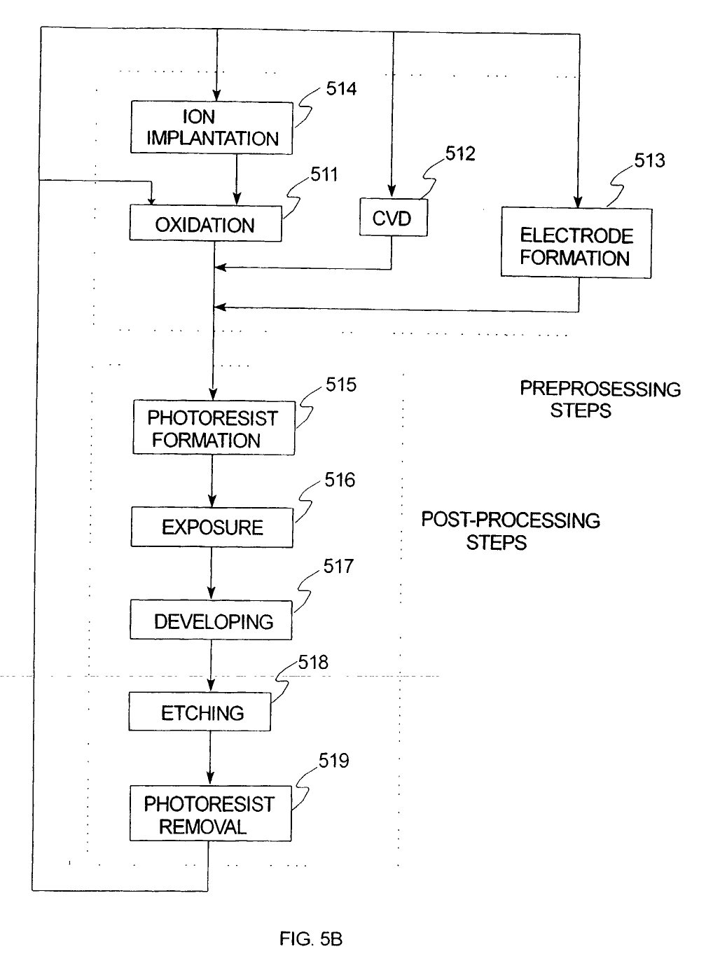

Semiconductor devices can be fabricated using the above described systems, by the process shown generally in FIG. 5A. In step 501 the device's function and performance characteristics are designed. Next, in step 502, a mask (reticle) having a pattern is designed according to the previous designing step, and in a parallel step 503 a wafer is made from a silicon material. The mask pattern designed in step 502 is exposed onto the wafer from step 503 in step 504 by a photolithography system described hereinabove in accordance with the present invention. In step 505 the semiconductor device is assembled (including the dicing process, bonding process and packaging process), finally, the device is then inspected in step 506.

FIG. 5B illustrates a detailed flowchart example of the above-mentioned step 504 in the case of fabricating semiconductor devices. In FIG. 5B, in step 511 (oxidation step), the wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above mentioned steps 511-514 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 515 (photoresist formation step), photoresist is applied to a wafer. Next, in step 516 (exposure step), the above-mentioned exposure device is used to transfer the circuit pattern of a mask (reticle) to a wafer. Then in step 517 (developing step), the exposed wafer is developed, and in step 518 (etching step), parts other than residual photoresist (exposed material surface) are removed by etching. In step 519 (photoresist removal step), unnecessary photoresist remaining after etching is removed.

Multiple circuit patterns are formed by repetition of these preprocessing and post-processing steps.

While the particular stage assembly 24 as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A stage assembly for positioning a device, the stage assembly comprising:
a device table;
a device holder that retains the device, the device holder being movable relative to the device table; and
a lock assembly that selectively locks the device holder to the device table without significantly deforming the device holder.

2. The stage assembly of claim 1 wherein the lock assembly selectively locks the device holder to the device table without significantly moving the device holder relative to the device table.

3. The stage assembly of claim 1 wherein the lock assembly extends between the device holder and the device table.

4. The stage assembly of claim 1 wherein the lock assembly includes a lock frame that moves relative to the device holder.

5. The stage assembly of claim 4 wherein the lock assembly includes a first clamp that secures the lock frame to the device holder and a second clamp that secures the lock frame to the device table.

6. The stage assembly of claim 5 wherein at least one of the clamps includes a vacuum source that creates a vacuum.

7. The stage assembly of claim 4 wherein the lock frame moves between a locked position in which the device holder is locked to the device table and an unlocked position in which the device holder is free to move relative to the device table.

8. The stage assembly of claim 7 wherein the lock assembly includes a lock support assembly that supports the lock frame and allows the lock frame to move between the positions.

9. The stage assembly of claim 1 wherein the lock frame moves between a locked position in which the device holder is locked to the device table and an unlocked position in which the device holder is supported kinematically on the device table.

10. The stage assembly of claim 1 further comprising a carrier supported relative to the device table and a holder connector assembly that flexibly connects the device holder to the carrier.

11. The stage assembly of claim 10 wherein the lock assembly selectively locks the device holder to the device table without significantly deforming the holder connector assembly.

12. The stage assembly of claim 10 wherein the carrier and the device holder rotate relative to the device table.

13. The stage assembly of claim 10 wherein the lock assembly selectively moves the carrier between a carrier locked position in which the carrier is locked to the device table and a carrier unlocked position in which the carrier is free to move relative to the device table.

14. The stage assembly of claim 13 wherein the lock assembly includes a first clamp that secures the lock frame to the device holder and a second clamp that secures the lock frame to the carrier.

15. The stage assembly of claim 1 further comprising a stage mover assembly that moves the device table.

16. An exposure apparatus including the stage assembly of claim 1.

17. A device manufactured with the exposure apparatus according to claim 16.

18. A wafer on which an image has been formed by the exposure apparatus of claim 16.

19. A stage assembly for positioning a device, the stage assembly comprising:
a device table;
a device holder that retains the device, the device holder being flexibly supported relative to the device table; and
a lock assembly including a lock frame that moves relative to the device holder to selectively lock the device holder to the device table.

20. The stage assembly of claim 19 wherein the lock assembly locks the device holder to the device table without significantly deforming the device holder.

21. The stage assembly of claim 19 wherein the lock assembly locks the device holder to the device table without significantly moving the device holder relative to the device table.

22. The stage assembly of claim 19 wherein the lock assembly includes a first clamp that secures the lock frame to the device holder and a second clamp that secures the lock frame to the device table.

23. The stage assembly of claim 22 wherein at least one of the clamps includes a vacuum source that creates a vacuum.

24. The stage assembly of claim 19 wherein the lock frame moves between a locked position in which the device holder is locked to the device table and an unlocked position in which the device holder is free to move relative to the device table.

25. The stage assembly of claim 24 wherein the lock assembly includes a lock support assembly that supports the lock frame and allows the lock frame to move between the positions.

26. The stage assembly of claim 19 wherein the lock frame moves between a locked position in which the device holder is locked to the device table and an unlocked position in which the device holder is supported kinematically on the device table.

27. The stage assembly of claim 19 further comprising a carrier supported relative to the device table and a holder connector assembly that flexibly connects the device holder to the carrier.

28. The stage assembly of claim 27 wherein the lock assembly selectively locks the device holder to the device table without significantly deforming the holder connector assembly.

29. The stage assembly of claim 27 wherein the carrier and the device-holder rotate relative to the device table.

30. The stage assembly of claim 27 wherein the lock assembly selectively moves the carrier between a carrier locked position in which the carrier is locked to the device table and a carrier unlocked position in which the carrier moves relative to the device table.

31. The stage assembly of claim 30 wherein the lock assembly includes a first clamp that secures the lock frame to the device holder and a second clamp that secures the lock frame to the carrier.

32. The stage assembly of claim 19 further comprising a stage mover assembly that moves the device table.

33. An exposure apparatus including the stage assembly of claim 19.

34. A device manufactured with the exposure apparatus according to claim 33.

35. A wafer on which an image has been formed by the exposure apparatus of claim 33.

36. A method for making a stage assembly that holds a device, the method comprising the steps of:
providing a device table that is supported movably;
movably securing a device holder that retains the device to the device table; and
fixedly securing the device holder to the device table with a lock assembly without significantly deforming the device holder.

37. The method of claim 36 wherein the step of fixedly securing includes locking the device holder to the device table without significantly moving the device holder relative to the device table.

38. The method of claim 36 wherein the step of fixedly securing includes the step of providing a lock frame that moves relative to the device holder.

39. The method of claim 38 wherein the step of fixedly securing includes the step of securing the lock frame to the device holder with a first clamp and securing the lock frame to the device table with a second clamp.

40. The method of claim 38 wherein the step of fixedly securing includes the step of moving the lock frame between a locked position in which the device holder is locked to the device table and an unlocked position in which the device holder is free to rotate relative to the device table.

41. The method of claim 40 wherein the step of fixedly securing includes the step of supporting the lock frame with a lock support assembly that allows the lock frame to move between the positions.

42. The method of claim 38 wherein the step of fixedly securing includes the step of moving the lock frame between a locked position in which the device holder is locked to the device table and an unlocked position in which the device holder is kinematically supported relative to the device table.

43. The method of claim 36 further comprising the step of supporting the device holder relative to the device table with a carrier and a holder connector assembly that flexibly connects the device holder to the carrier.

44. The method of claim 43 wherein the lock assembly selectively locks the device holder to the device table without significantly deforming the holder connector assembly.

45. A method for making an exposure apparatus that forms an image on an object, the method comprising the steps of:
providing an irradiation apparatus that irradiates the object with radiation to form the image on the object; and
providing the stage assembly made by the method of claim 36.

46. A method of making a wafer utilizing the exposure apparatus made by the method of claim 45.

47. A method of making a device including at least the exposure process: wherein the exposure process utilizes the exposure apparatus made by the method of claim 45.

48. A method for making a stage assembly that holds a device, the method comprising the steps of:
providing a device table that is supported movably;
movably securing a device holder that retains the device to the device table; and
fixedly securing the device holder to the device table with a lock assembly without significantly moving the device holder.

49. The method of claim 48 wherein the step of fixedly securing includes the step of providing a lock frame that moves relative to the device holder.

50. The method of claim 49 wherein the step of fixedly securing includes the step of securing the lock frame to the device holder with a first clamp and securing the lock frame to the device table with a second clamp.

51. The method of claim 49 wherein the step of fixedly securing includes the step of moving the lock frame between a locked position in which the device holder is locked to the device table and an unlocked position in which the device holder is free to rotate relative to the device table.

52. The method of claim 51 wherein the step of fixedly securing includes the step of supporting the lock frame with a lock support assembly that allows the lock frame to move between the positions.

53. The method of claim 49 wherein the step of fixedly securing includes the step of moving the lock frame between a locked position in which the device holder is locked to the device table and an unlocked position in which the device holder is kinematically supported relative to the device table.

54. The method of claim 48 further comprising the step of supporting the device holder relative to the device table with a carrier and a holder connector assembly that flexibly connects the device holder to the carrier.

55. The method of claim 54 wherein the lock assembly selectively locks the device holder to the device table without significantly deforming the holder connector assembly.

56. A method for making an exposure apparatus that forms an image on an object, the method comprising the steps of:
providing an irradiation apparatus that irradiates the object with radiation to form the image on the object; and
providing the stage assembly made by the method of claim 48.

57. A method of making a wafer utilizing the exposure apparatus made by the method of claim 56.

58. A method of making a device including at least the exposure process: wherein the exposure process utilizes the exposure apparatus made by the method of claim 56.
